(19) United States
(12) Patent Application Publication
(10) Pub. No.: US 2014/0230328 A1
(43) Pub. Date: Aug. 21, 2014

(54) FLAP GATE-TYPE WATERPROOF PANEL FOR WALL INSTALLATION

(71) Applicants: Masaki Inui, Osaka (JP); Yuuichirou Kimura, Osaka (JP); Kyouichi Nakayasu, Osaka (JP); Toshiaki Morii, Osaka (JP); Yoshito Yamakawa, Osaka (JP)

(72) Inventors: Masaki Inui, Osaka (JP); Yuuichirou Kimura, Osaka (JP); Kyouichi Nakayasu, Osaka (JP); Toshiaki Morii, Osaka (JP); Yoshito Yamakawa, Osaka (JP)

(73) Assignee: HITACHI ZOSEN CORPORATION, Osaka-shi, Osaka (JP)

(21) Appl. No.: 14/350,694

(22) PCT Filed: Sep. 7, 2012
(86) PCT No.: PCT/JP2012/072937

§ 371 Date: Apr. 9, 2014

(30) Foreign Application Priority Data
Oct. 19, 2011 (JP) 2011-229768

(51) Int. Cl. E06B 9/00; E06B 5/00

(52) U.S. Cl. CPC E06B 9/00; E06B 5/003; E06B 2009/007
USPC 49/11

(57) ABSTRACT

The present invention utilizes a vertically upward force of a water when a tsunami smashes into a building to close openings that exist in an elevated location such as air supply and exhaust ducts, powerlessly and without a manual operation. The present invention serves as a disaster prevention panel which closes an opening 2a disposed in a wall of a building 2. A door bumper 3 is disposed on an outer peripheral wall of the opening 2a, and side door bumpers 4 are disposed on both sides of the door bumper 3. A door body 1, which closes the opening 2a and which has a specific gravity lower than a seawater, is attached between the side door bumpers 4 on both sides so as to freely swing upwards, with a lower portion of the door bumper 3 serving as a fulcrum.

### TECHNICAL FIELD

The present invention relates to a flap gate-type waterproof panel for a wall installation which closes openings that exist in an elevated location such as air supply and exhaust ducts installed in fixed structures, thus making it possible to prevent an influx of a tsunami, powerlessly and without a manual operation, even if a hood or a ventilation fan is present in the vicinity of the opening.

### BACKGROUND ART

In the event that a tsunami smashes into a fixed structure such as a reinforced concrete building (referred to below as a building), there is an influx of water into the building from openings such as windows, doors, air supply and exhaust ducts, and the like, which are positioned lower than the wave height of the tsunami.

In such an event, if the openings are disposed at low elevations such as windows and doors, people who live in the building are able to prevent an influx of water by closing the openings before the tsunami arrives (e.g., Patent Reference 1).

However, if openings such as air supply and exhaust ducts are present in an elevated location, and if an air intake and exhaust system such as a ventilation fan is present in the vicinity of the openings, a mechanism for closing the openings becomes complicated. In addition, it takes time to close the openings manually, and the people involved in the closing operation are exposed to danger. Patent Reference 1: Japanese Patent Publication No. 2001-521089

### SUMMARY OF THE INVENTION

### Problems to be Solved by the Invention

One problem which the present invention aims to solve is that, in the event that a tsunami smashes into a building, if openings such as air supply and exhaust ducts are located in an elevated position, and if an air intake and exhaust system is present in the vicinity of the openings, a mechanism for closing the openings becomes complicated. Another problem is that it takes time to close the openings manually, and the people involved in the closing operation are exposed to danger.

### Means for Solving these Problems

The present invention has as its object to provide a flap gate-type waterproof panel which closes an opening located in an elevated location, as well as an opening where an air intake and exhaust system is present, powerlessly and without manual operation, by utilizing a vertically upward force of a water when a tsunami smashes into a building.

The flap gate-type waterproof panel for wall installation according to the present invention is a disaster prevention panel which closes an opening located in a wall of a building, having as its most essential features:
a door bumper disposed on an outer peripheral wall of the opening, and side door bumpers located on both sides of the door bumper, and
a door body which closes the opening and which has a specific gravity lower than a seawater, and which is attached between the side door bumpers on both sides so as to freely swing upwards, with a lower portion of the door bumper serving as a fulcrum.

The present invention is able to prevent an influx of water into a building by closing the openings of the building powerlessly and without manual operation, because the door body swings upwards by utilizing a vertically upward force of the water which smashes into the building.

### Advantageous Effects of the Invention

According to the present invention, people living in a building are able to focus on escaping to a higher elevation, because the present invention makes it possible to prevent an influx of water into the building by closing the openings of the building powerlessly and without manual operation. This ensures safety, and also makes it possible to protect assets inside the building from water infiltration resulting from the tsunami.

### BRIEF DESCRIPTION OF THE DRAWINGS

FIGS. 1 (a) and (b) are drawings illustrating the first example of a flap gate-type waterproof panel for wall installation according to the present invention. FIG. 1 (a) is a front view. FIG. 1 (b) is a lateral sectional view.

FIGS. 2 (a)-(d) are drawings illustrating successive stages of closing by a flap gate-type waterproof panel for wall installation according to the present invention.

FIGS. 3 (a) and (b) are drawings illustrating the second example of a flap gate-type waterproof panel for wall installation according to the present invention. FIG. 3 (a) is a lateral sectional view. FIG. 3 (b) is a drawing illustrating a mechanism for maintaining a raised position.

FIGS. 4 (a) and (b) are drawings illustrating the third example of a flap gate-type waterproof panel for wall installation according to the present invention in a manner similar to FIG. 1.

FIG. 5 is a lateral sectional view illustrating the fourth example of a flap gate-type waterproof panel for wall installation according to the present invention.

FIGS. 6 (a) and (b) are drawings illustrating the fifth example of a flap gate-type waterproof panel for wall installation according to the present invention in a manner similar to FIG. 1.

### DETAILED DESCRIPTION OF THE PREFERRED EMBODIMENTS

The present invention has as its object to close an opening located in an elevated location, as well as an opening where an air intake and exhaust system is present, powerlessly and without manual operation, by utilizing a vertically upward force of a water when a tsunami smashes into a building.

The aforementioned object of the present invention is achieved by attaching a door body having a specific gravity lower than a seawater between side door bumpers provided at an opening so as to freely swing upwards, with a lower portion of a door bumper serving as a fulcrum.

### EXAMPLES

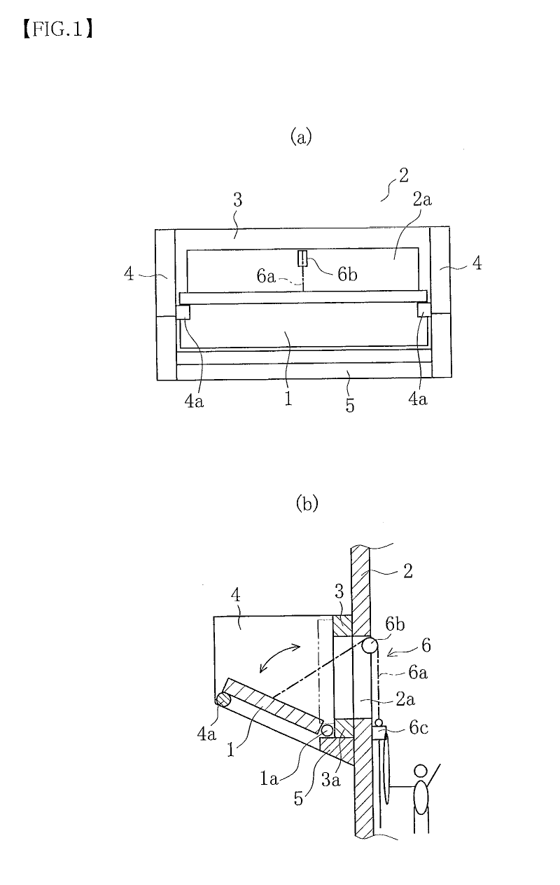

Embodiments of the present invention are described in detail below, making use of FIGS. 1-6.

FIG. 1 is a drawing illustrating the first example of a flap gate-type waterproof panel for a wall installation according to the present invention.

The present invention prevents an influx of a tsunami into a building by closing an opening by raising a disaster prevention panel by utilizing the fact that a tsunami which crashes into a building ascends a wall in a vertical direction. An example of the structure of the present invention is shown in FIG. 1.

Reference Numeral 1 is a door body made from a metal such as stainless steel, for example, and is formed with a hollow internal portion so that it has a specific gravity lower than seawater. Since the door body 1 is so formed, it is able to respond, even in a case in which a tsunami does not impact a building 2 from the front and does not ascend a wall of the building 2 in a vertical direction, or even in a case in which a tsunami impacts from the front of the building 2, but lacks sufficient vertical force to ascend the wall of the building 2 and thus a water level gradually rises.

Reference Numeral 3 is a door bumper disposed at an outer peripheral wall on an outer side of an opening 2a in a wall of the building 2, and made from a metal or concrete. As needed, a water-tight rubber (not pictured) is attached to the door bumper 3, so that the door bumper 3 will form a water-tight lining which makes contact with the door body 1 when closing the opening 2a. At the lower portion of the door bumper 3 there is provided an attaching member 3a of a hinge member 1a which forms a center point when the door body 1 swings upwards. As needed, a water-tight rubber can be attached to this hinge member la as well.

In the example shown in FIG. 1, a current rectifier 5 is installed at the lower portion of the door bumper 3. The lower surface of this current rectifier 5 is installed so as to incline in an upward direction at 5-80° from a horizontal plane, in order to reduce an impact of the tsunami which operates on the door body 1. This has the effect of eliminating a vertical impact of the flow of the tsunami on the door body 1, by changing the flow direction of the tsunami ascending the wall from a vertical upward direction to an upstream direction of the tsunami.

Reference Numeral 4 is a side door bumper installed along a side end surface of the door body 1 on both sides of the door bumper 3 to prevent an influx of a tsunami from a side of the door body 1 or an influx of water having a level which is gradually rising. The side door bumper 4 is, for example, made from metal or concrete, like the door bumper 3. As needed, a water-tight rubber (not pictured) can also be attached to a portion of the door body 1 which touches the side door bumper 4.

The lower surface of this side door bumper 4 is also caused to incline in an upward direction at 5-80° from a horizontal plane, in order to reduce an impact of the tsunami. In addition, a receiving member 4a is provided on an inner side of the side door bumper 4 to support the door body 1.

It is desirable to have the door body 1 supported by the receiving member 4a in a stand-by state such that it inclines in an upward direction at 5-80° from a horizontal plane, so that when a tsunami approaches, it will deflect the flow of the tsunami and reduce the force of its impact. This is because if the flow of the tsunami operates vertically on the door body surface, the force of impact on the door body 1 becomes great, causing the door body 1 to violently swing upwards, damaging it, and there is a risk that the door body 1 will crash against the door bumper 3, resulting in damage to both.

The flap gate-type waterproof panel for wall installation according to the present invention comprises at least the door body 1, the door bumper 3, and the side door bumper 4, but, in the example shown in FIG. 1, a manual opening and closing device 6 is also provided inside the building 2 so that operation of the door body 1 will not be hindered by the tsunami.

This opening and closing device 6 is constructed such that a chain 6a has one end attached at a position separated from the hinge member 1a of the door body 1 and thus has the other end wound or unwound by using a chain block 6c via a sprocket 6b. If such an opening and closing device 6 is installed, the door body 1 can be manually opened or closed, if there is leeway in terms of time, and also when operation of the system is being inspected.

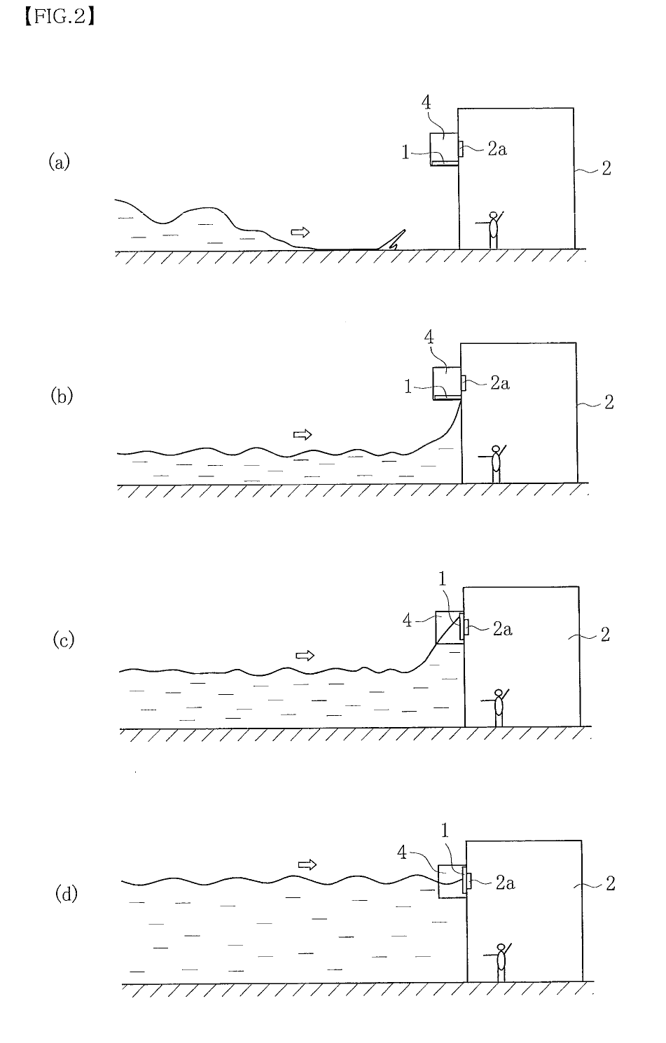

As shown in FIG. 2, if a disaster prevention panel having the above-described structure according to the present invention is installed in the opening 2a of the building 2, when a tsunami approaches (see FIG. 2 (a)), the opening 2a is closed in a manner described below, thus preventing the tsunami from entering the building.

When a wave height increases because the approaching tsunami smashes against the wall of the building 2 and rebounds (see FIG. 2 (b)), the door body 1 is raised powerlessly and without manual operation, utilizing the force of the water ascending the wall (see FIG. 2 (c)), thereby closing the opening 2a (see FIG. 2 (d)).

In a case where a tsunami has no force, but a water level gradually rises so that a surface of the water reaches the opening 2a, a buoyancy of the door body 1 causes the door body 1 to rise together with rising water level, powerlessly and without manual operation, closing the opening 2a as shown in FIG. 2 (d), thus preventing the tsunami from entering the building.

An opening and closing device 7 as shown in FIG. 3 may be used instead of the opening and closing device 6. The opening and closing device 7 has a wire rope 7a one end of which is attached at a position separated from the hinge member 1a of the door body 1 and the other end of which is wound around a wire drum 7b. In addition, one end of a wire rope 7e is wrapped around a wire drum 7c attached coaxially to the wire drum 7b. To the other end of the wire rope 7e there is attached a counterweight 7d which operates in a direction which raises the door body 1. Moreover, a unidirectional clutch 7f which allows rotation of the door body 1 only in the rising direction is attached coaxially to the wire drum 7c.

In cases where such an opening and closing device 7 is installed, when the door body 1 starts to rise as the tsunami arrives, the counterweight 7d helps the door body 1 to rise, by rotating the wire drums 7b, 7c, because the counterweight 7d operates as an auxiliary force while the door body 1 is rising. When this happens, even if the door body 1 tries to lower, the unidirectional clutch 7f prevents the door body 1 from lowering, thus keeping it in a raised position.

In FIG. 3, a sprocket 7g is attached coaxially to the unidirectional clutch 7f, and a chain 7h links the sprocket 7g to a sprocket 7j which is attached to a decelerator 7i. If such a configuration is used, when a handle 7m of the decelerator 7i is rotated, a rotational force is transmitted via the chain 7h to the wire drums 7c, 7b, thus making it possible to wind the wire rope 7a.

The present invention is not limited to the above-described examples, and the embodiment may, of course, be advantageously modified within the scope of the technical ideas recited in the claims.

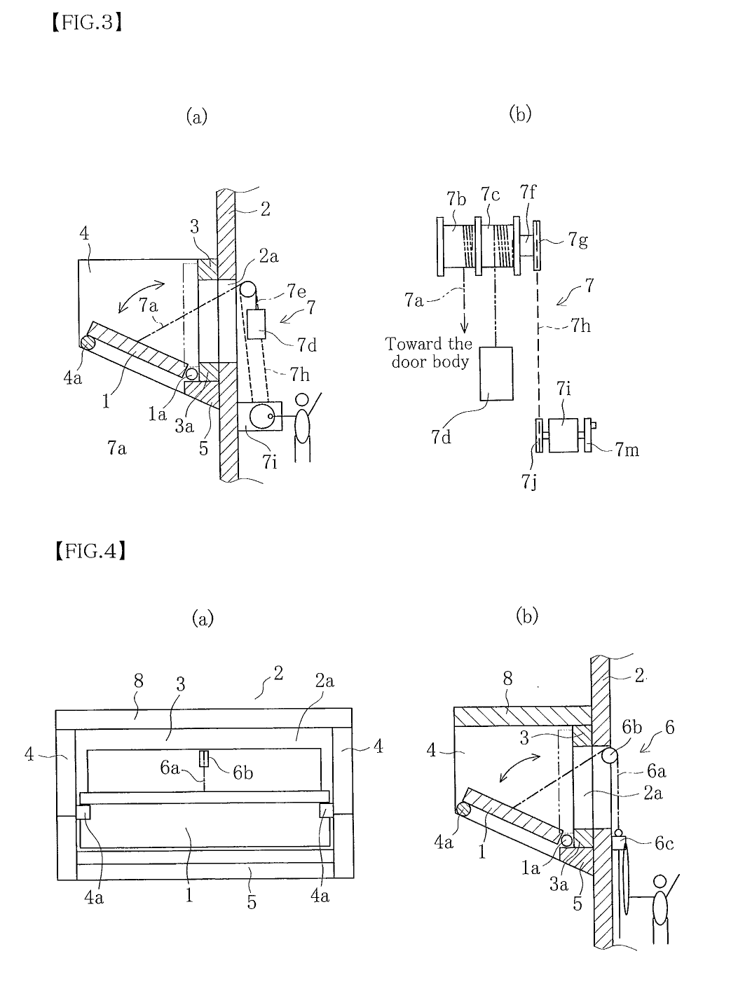

For example, as shown in FIG. 4, a metal or concrete upper door bumper 8 may be attached to keep rain out. If this upper door bumper 8 is attached, a water-tight rubber may be attached to the front end of the door body 1, as needed, to form a water-tight lining.

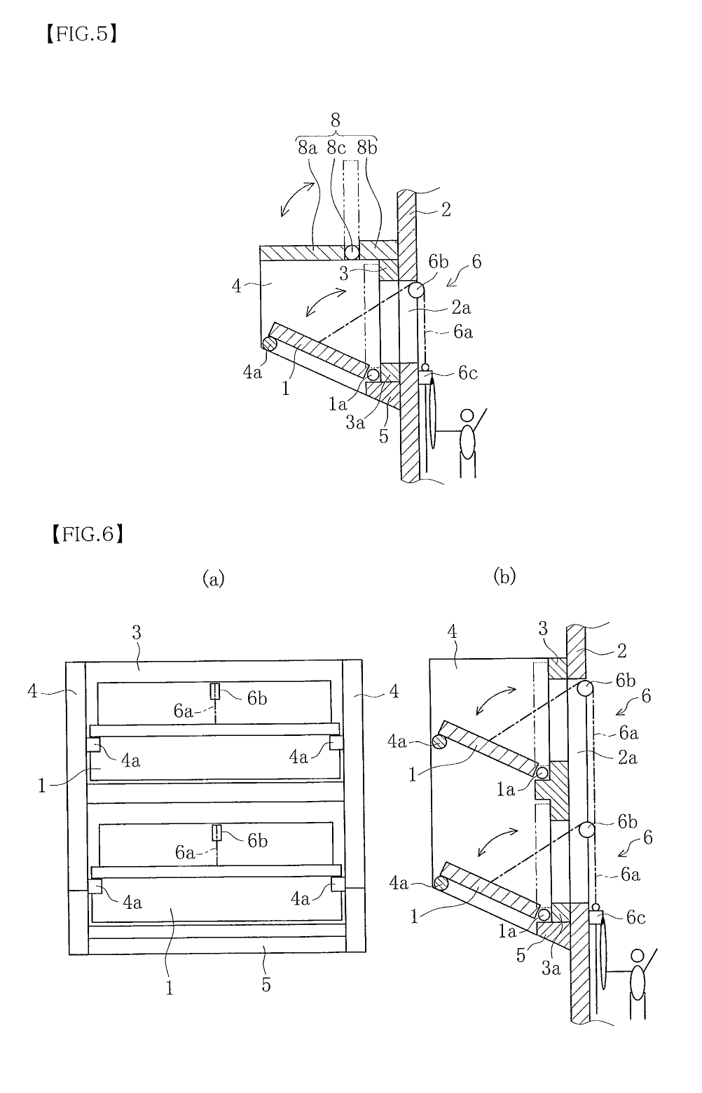

Since it is anticipated that the upper door bumper 8 will be subjected to the wave force of the tsunami, a front end portion 8a and a base end portion 8b of the upper door bumper 8 are linked with a hinge 8c to form a flap-type member, resulting in a structure which will deflect the tsunami wave force, as shown in FIG. 5.

In the examples shown in FIGS. 1, 3, 4, and 5, the opening 2a is closed with a single door body 1. However, as shown in FIG. 6, the opening 2a may be closed with a plurality of door bodies 1 attached in a height direction (there are 2 door bodies in FIG. 6). If such a configuration is used, the opening 2a can be closed while reducing amount of stretching from the wall surface, even if the opening 2a is long in the height direction.

### EXPLANATION OF THE REFERENCE NUMERALS

1 Door body
1 a Hinge member
2 Building
2a Opening
3 Door bumper
4 Side door bumper
5 Current rectifier
7 Opening and closing device
7a Wire rope
7b Wire drum
7d Counterweight
7f Unidirectional clutch

1. A flap gate-type waterproof panel for wall installation, serving as a disaster prevention panel which closes an opening located in a wall of a building, the panel comprising:
a door bumper disposed on an outer peripheral wall of the opening, and side door bumpers located on both sides of the door bumper, and
a door body which closes the opening and which has a specific gravity lower than a seawater, and which is attached between the side door bumpers on both sides so as to freely swing upwards, with a lower portion of the door bumper serving as a fulcrum.

2. A flap gate-type waterproof panel for wall installation according to claim 1, further comprising
a wire rope having one end attached to the door body and the other end wound on a wire drum,
a counterweight being attached coaxially to the wire drum and operating in a direction which raises the door body, and
a unidirectional clutch being attached coaxially to the wire drum to allow rotation of the
door body only in the rising direction.

3. A flap gate-type waterproof panel for wall installation according to claim 1, wherein the door body is in a stand-by state, inclining in an upward direction at 5-80° from a horizontal plane.

4. A flap gate-type waterproof panel for wall installation according to claim 1, further comprising a current rectifier installed at the lower portion of the door bumper to change a direction of a tsunami from a vertical direction to an upstream direction of the tsunami.

5. A flap gate-type waterproof panel for wall installation according to claim 3, further comprising a
current rectifier installed at the lower portion of the door bumper to change a direction of a tsunami from a vertical direction to an upstream direction of the tsunami.

6. A flap gate-type waterproof panel for wall installation according to claim 1, wherein a plurality of door bodies are attached in a height direction.

7. A flap gate-type waterproof panel for wall installation according to claim 3, wherein a plurality of door bodies are attached in a height direction.

8. A flap gate-type waterproof panel for wall installation according to claim 4, wherein a plurality of door bodies are attached in a height direction.
